(19) United States
(12) Patent Application Publication
(10) Pub. No.: US 2008/0125073 A1
(43) Pub. Date: May 29, 2008

(54) MIXER AND SIGNAL PROCESSING METHOD, SYSTEM-ON-CHIP COMPRISING SUCH A MIXER

(75) Inventors: Benoit Butaye, Pierre Semard (FR); Manuel Camus, Marechal Joffre (FR)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMICROELECTRONICS SA, Montrouge (FR)

(21) Appl. No.: 11/942,171

(22) Filed: Nov. 19, 2007

(30) Foreign Application Priority Data
Nov. 24, 2006 (FR) 06 10288

(51) Int. Cl. H04B 1/26; H04M 1/00

(52) U.S. Cl. 455/323; 455/550.1

(57) ABSTRACT

A radiofrequency mixer multiplies a first radiofrequency signal by a second radiofrequency signal, wherein the first radiofrequency signal is: either a differential signal, corresponding to the difference between a first signal component and a second signal component, each corresponding to a respective approximately square signal of a duty cycle strictly below 0.5, or a single-ended signal which is a non-differential approximately square signal for which the duty cycle is strictly below 0.5.

### TECHNICAL FIELD

The present disclosure generally relates to the processing of radiofrequency (RF) signals, and has applications particularly but not exclusively in integrated circuits which are receivers for RF signals comprising a multiplier, also called a mixer.

Such integrated circuit devices are found in mobile telephones for example.

### BACKGROUND INFORMATION

A mixer is a circuit adapted to multiply a signal corresponding to a received RF signal of frequency F_{RF} and an oscillation signal of frequency F_{LO} generated by a local oscillator in the receiver, in order to extract a component of the resulting signal at a×F_{RF}+b×F_{LO} where a and b are integer non-zero numbers. For example, the extracted component corresponds to (a;b)=(1;−1) or (−1;1).

FIG. 1 shows a standard radiofrequency receiver 1 in a system-on-chip, comprising a low noise amplifier 2 or LNA, a mixer 3, an oscillation signal generator 4, and a post-mixer amplifier or PMA with a filter 14.

The mixer 3 is a passive mixer, meaning it operates without bias current.

The low noise amplifier 2 is adapted to receive a radiofrequency signal S and deliver a signal S′ resulting from a first amplification of the signal S by the receiver, with little degradation to the signal-to-noise ratio.

In the case shown in FIG. 1, this signal S′ is then processed in parallel in two processing channels: a channel I and a channel Q.

The mixer 3 comprises an input terminal b adapted to receive when operational the signals delivered by the signal generator 4, and a multiplier 9 which comprises a mixing module 10, 11 for each of the channels I and Q. The mixer 3 additionally comprises two capacitors 12, 13 of the same capacitance C, with one of the capacitors placed parallel to the output of the mixing module 10, and the other placed parallel to the output of the mixing module 11. Each capacitor acts as a low pass filter.

The oscillation signal generator 4 is adapted to provide to the mixing module 10 of the mixer 3, via the input terminal b, on channels 5, 6, a differential oscillation signal TI of frequency F_{LO}, and to provide to the mixing module 11, via the terminal b, on channels 7, 8, a differential oscillation signal TQ of frequency F_{LO}.

The differential signal TI is equal to the difference TIP−TIM, where TIM and TIP are approximately square signals of duty cycle α=0.5, in phase opposition, of frequency F_{LO}, delivered by the generator 4 on channel 5 and 6 respectively. The duty cycle α designates the ratio between the time (τ) at the high state during a period (T) and the period (T), or

$$α = \frac{τ}{T} .$$

The differential signal TQ is equal to the difference TQP−TIM, where TQM and TQP are approximately square signals of duty cycle α=0.5, in phase opposition, of frequency F_{LO}, delivered by the generator 4 on channel 5 and 6 respectively.

The oscillation signals TI and TQ of the respective channels I and Q are generally out of phase by 90°.

In the case in question, the mixer 3 is a passive voltage-to-voltage mixer (dependent on the ratio between the output impedance and input impedance), meaning that it is characterized by a transfer of the input voltage to an output voltage.

The voltage of the signal S′ is delivered to the inputs of each mixing module 10, 11.

This voltage is mixed by the mixing module 10 with the voltage of the signal TI (meaning that the voltage of the signal S′ is multiplied by the voltage of the signal TI) and it is mixed by the mixing module 11 with the voltage of the signal TQ (meaning that the voltage of the signal S′ is multiplied by the voltage of the signal TQ).

The mixing module 10 delivers a signal S_{I}″ of a voltage equal to the mixed voltages of signals S′ and TI.

The mixing module 11 delivers a signal S_{Q}″ of a voltage equal to the mixed voltages of signals S′ and TQ.

The capacitors 12 and 13 eliminate the high frequencies of signals S_{I}″ and S_{Q}″, meaning the signal frequencies exceeding the frequency ±(F_{RF}−F_{LO}), in particular the components located at frequency F_{RF}+F_{LO}, and provide as input to the post-mixer amplifier with filter 14 the components of signals S_{I}″ and S_{Q}″ at frequency ±F_{IF}=±(F_{RF}−F_{LO}). The post-mixer amplifier with filter 14 extracts the desired component from each channel I and Q for subsequent processing (not represented) in the receiver 1. For example, the component at frequency (+F_{IF}) is extracted and the component at the opposite frequency is eliminated. In another example, the frequency (−F_{IF}) is extracted and the component at the opposite frequency is eliminated. The value of F_{IF} is positive or negative depending on the case.

Such processing allows creating a mixer 3 with image rejection because during the processing sequence it differentiates between the signal S at frequency F_{RF}=F_{LO}+F_{IF} and the image signal of frequency F_{LO}−F_{IF}.

Such a mixer has a voltage gain which is equal to

$$\frac{2}{π} = - 3.92 dB .$$

As an illustration, in one embodiment the voltage signal S′ is a signal of type A cos(F_{RF}t) as represented by the thin line in FIGS. 3.1 and 3.2. The voltage signals TIM and TIP (channel 1) of frequency F_{LO} are represented in FIG. 2.1. The voltage signals TQM and TQP (channel Q) of frequency F_{LO} are represented in FIG. 2.2.

The signals on channel I at the output of the mixer 3 are represented as a thick line in FIG. 3.1 and the signals on channel Q at the output of the mixer 3 are represented as a thick line in FIG. 3.2, in the special case where the capacitance of the capacitors 12 and 13 is zero (C=0 F).

The gain in the mixer 3 corresponds to the mean of the corrected signal S_{I,Q}″ divided by the amplitude of the input signal.

### BRIEF SUMMARY

There is a need for a mixer presenting a better gain than the gain of −3.92 dB.

For this purpose, a first aspect of the invention proposes a mixer presenting an improved gain.

A radiofrequency mixer according to the first aspect of the invention comprises:

a terminal from which a first radiofrequency signal is available, when operational,

an input for receiving a second radiofrequency signal,

a means of multiplication for multiplying the first radiofrequency signal and the second radiofrequency signal.

In a mixer of one embodiment of the invention, the first radiofrequency signal is:

either a differential signal corresponding to the difference between a first component of the signal and a second component of the signal, each corresponding to a respective signal which is approximately square and of a duty cycle strictly below 0.5,

or a single-ended signal which is a non-differential approximately square signal of a duty cycle strictly below 0.5.

Such a mixer allows obtaining an output gain which is better than the gain presented by mixers of the prior art.

In one embodiment, the duty cycle of the approximately square signal corresponding to each signal component of the first radiofrequency signal, the respective duty cycles of the non-differential approximately square signal, is less than 0.25, which allows obtaining a further increase in the gain.

In one embodiment, the mixer comprises an output for delivering a voltage indicating the result of the multiplication of the first radiofrequency signal and the second radiofrequency signal, and comprising a capacitor parallel to said output.

This allows either decreasing the cutoff frequency of the low-pass filter corresponding to the capacitor, or decreasing the size of the capacitor necessary at an equal cutoff frequency.

In one embodiment, the first radiofrequency signal has a first frequency and the second radiofrequency signal has a second frequency, and the absolute value of the quotient of the second frequency divided by the first frequency is between 0.5 and 2 (not including 0.5 and 2).

In one embodiment, the first signal is a differential signal and the means of multiplication comprises two differential input terminals and two differential output terminals, and:

the first input terminal is connected to the common sources of a first and second transistor, the second input terminal is connected to the common sources of a third and fourth transistor,

the common gates of the first and fourth transistors receive the first component of the first signal and the common gates of the second and third transistors receive the second component of the first signal.

the first output terminal is connected to the common drains of the first and third transistors, the second output terminal is connected to the common drains of the second and fourth transistors.

A second aspect of the invention proposes a system-on-chip comprising a mixer according to the first aspect of the invention.

A third aspect of the invention proposes a method for processing signals in a mixer adapted to multiply a first radiofrequency signal with a second radiofrequency signal.

In the process of one embodiment of the invention, the first radiofrequency signal is:

either a differential signal corresponding to the difference between a first signal component and a second signal component, each respectively corresponding to an approximately square signal for which the duty cycle is strictly below 0.5,

or a single-ended signal which is a non-differential approximately square signal for which the duty cycle is strictly below 0.5.

### BRIEF DESCRIPTION OF THE SEVERAL VIEWS OF THE DRAWINGS

Other features of one or more non-limiting and non-exhaustive embodiments of the invention will be further illustrated by the description which follows. This is purely illustrative and should be read with reference to the attached drawings, where:

FIG. 1 shows a standard radiofrequency receiver,

FIGS. 2.1-2.2 show voltage signals for the receiver of FIG. 1,

FIGS. 3.1-3.2 also show voltage signals for the receiver of FIG. 1,

FIG. 4 represents a mixer in one embodiment of the invention,

FIG. 5.1 represents the evolution of a differential oscillation signal on channel I in the mixer in FIG. 4 during a window of time according to an embodiment,

FIG. 5.2 represents the evolution of a differential oscillation signal on channel Q in the mixer in FIG. 4 during a window of time according to an embodiment,

FIG. 6.1 represents the evolution of the input and output signals of the mixer in FIG. 4 on channels I and Q during a window of time, for two capacitance values C1, when the duty cycle is equal to 1/10, according to an embodiment,

FIG. 6.2 represents the evolution of the input and output signals of the mixer in FIG. 4 on channels I and Q during a window of time, for two capacitance values C1, when the duty cycle is equal to ¼, according to an embodiment,

FIG. 7 represents the mixer gain in one embodiment of the invention as a function of the duty cycle,

FIG. 8 schematically represents an embodiment of an oscillation signal generator with a duty cycle which is equal to 0.25,

FIG. 9 schematically represents an embodiment of an oscillation signal generator with a duty cycle which is strictly below 0.25.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

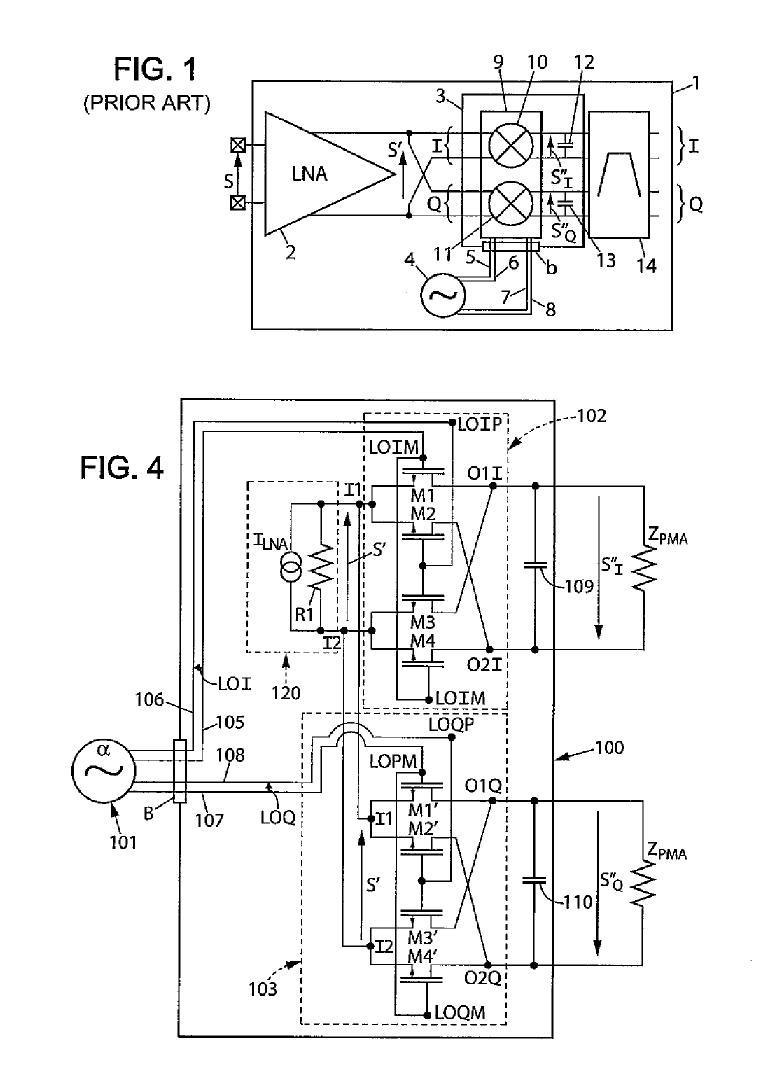

In one embodiment of the invention, in a radiofrequency receiver of a system-on-chip of the type represented in FIG. 1 (for example a system-on-chip in a mobile telephone), the mixer 3 and the generator 4 are respectively replaced by the mixer 100 and the generator 101 represented in FIG. 4, and the capacitors 12, 13 by the capacitors 109, 110.

The mixer 100 comprises a terminal B adapted to interface with the signal generator 101 and to receive the oscillation signals delivered by this generator, a mixing module 102 for channel I, and a mixing module 103 for channel Q. The mixer 100 additionally comprises the capacitor 109 which is parallel to the output of the mixing module 102, and the capacitor 110 which is parallel to the output of the mixing module 103.

The capacitors 109 and 110 both have a capacitance value of C1.

The oscillation signal generator 101 provides to the mixing module 102, via the input terminal B of the mixer 100, a differential oscillation signal LOI of frequency F_{LO} on channels 105, 106, and provides to the mixing module 103 a differential oscillation signal LOQ of frequency F_{LO} on channels 107, 108.

The differential signal LOI is equal to the difference LOIP−LOIM, where LOIM and LOIP are approximately square signals of frequency F_{LO}, respectively delivered by the generator 101 on channels 105, 106.

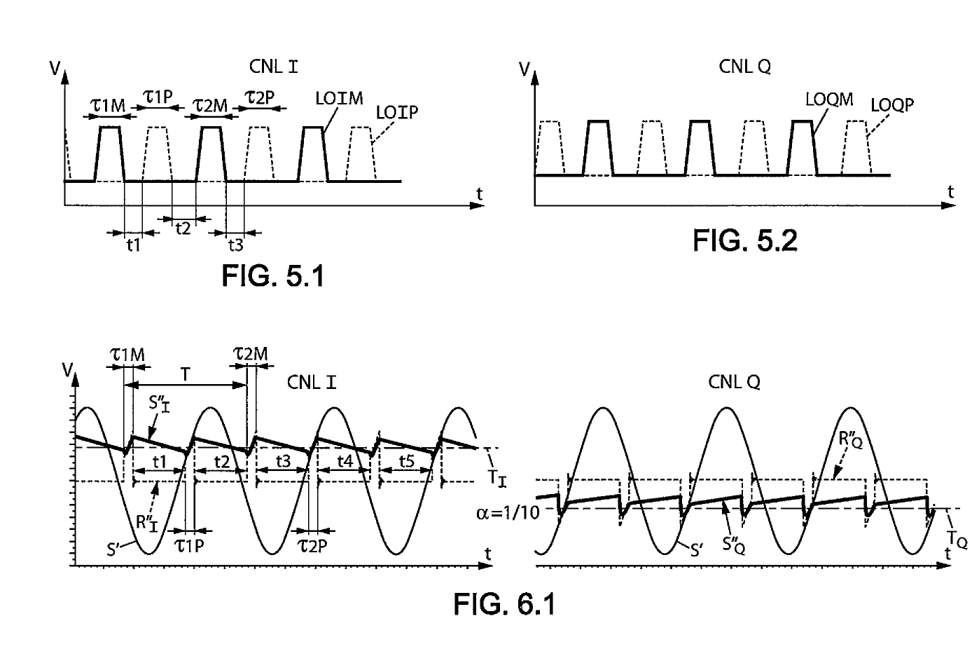

The voltage of the LOIM signal over time appears in FIG. 5.1 as a solid line, while the voltage of the LOIP signal is shown in FIG. 5.1 as a dotted line.

The differential signal TQ is equal to the difference LOQP−LOQM, where LOQM and LOQP are approximately square signals in phase opposition of frequency F_{LO}, respectively delivered by the generator 101 on channels 107, 108.

The voltage of the signal LOQM over time is shown in FIG. 5.2 as a solid line, while the voltage of the signal LOQP is shown in FIG. 5.1 as a dotted line.

Thus each oscillation signal LOIP, LOIM, LOQP and LOQM is an approximately square signal of frequency F_{LO}, of a duration τ at the high state and a duration T-τ at the low state (T being the period of these signals, equal to 1/F_{LO}), which corresponds to a duty cycle of

$$α = \frac{τ}{T} .$$

In one embodiment of the invention, the duty cycle for each of these oscillation signals is strictly below 0.5.

In one embodiment, the oscillation signals LOIM and LOIP are out of phase with each other by 180°. Similarly, the oscillation signals LOQM and LOQP are out of phase with each other by 180°.

The oscillation signals LOI and LOQ for the respective channels I and Q are out of phase with each other by 90°.

In the embodiment in question, the mixing module 102 for the channel I comprises two differential input terminals I1 and I2 between which the voltage S′ issuing from LNA 2 is applied, and two differential output terminals OI1 and OI2 between which the output voltage S_{I}″ of the module is delivered, with this output voltage indicating the result of the mixing (meaning the multiplication) of signal S′ and signal LOI.

The mixing module 102 of the channel I additionally comprises four CMOS transistors M1, M2, M3 and M4 used as switches.

As is shown in FIG. 4, parallel to the output of the mixing module 102 of the mixer 100 is represented an impedance Z_{PMA} which corresponds to the impedance presented by the PMA amplifier 14 in FIG. 1, corresponding to a voltage source between two resistances, which allows setting the bias of transistors M1, M2, M3 and M4.

It is also possible to set the bias of transistors M1, M2, M3 and M4 using an impedance similar to the impedance Z_{PMA} and provided upstream from the mixer, I on the side of the low noise amplifier.

The input terminal I1 is connected to the common sources of transistors M1 and M2, and the input terminal I2 is connected to the common sources of transistors M3 and M4. The common gates for transistors M1 and M4 are connected to the channel 105 for delivering the voltage of the oscillation signal LOIM, while the gates for transistors M2 and M3 are connected to the channel 106 delivering the voltage of the oscillation signal LOIP.

The output terminal O1I is connected to the common drains of transistors M1 and M3. The output terminal O2I is connected to the common drains of transistors M2 and M4.

The mixing module 103 for the channel Q comprises the differential input terminals I1 and I2, between which the voltage S′ issuing from the LNA 2 is applied. It additionally comprises two differential output terminals OQ1 and OQ2, between which the output voltage S_{Q}″ of the module is delivered, with this output voltage indicating the result of the mixing of signal S′ and signal LOQ.

The mixing module 103 of the channel Q additionally comprises four CMOS transistors M1′, M2′, M3′ and M4′, assembled similarly to the respective transistors M1, M2, M3 and M4 of the mixing module 102.

Additionally represented in FIG. 4 is an impedance Z_{PMA} parallel to the output of the mixing module 103 which corresponds to the impedance presented by the PMA amplifier 14 in FIG. 1, corresponding to a voltage source between two resistances, which allows setting the bias of transistors M1′, M2′, M3′ and M4′.

The operation of an embodiment of the mixing module 102 during a period T is described below. The operation of the mixing module 103 is similar.

Based on their being assembled as represented in FIG. 4, the transistors M1 and M4 are conducting at the same time and non-conducting at the same time. Similarly, the transistors M2 and M3 are conducting at the same time and non-conducting at the same time.

In the described embodiment, the radiofrequency receiver comprising the mixer 100 is a NZIF receiver. The frequency F_{RF} of the radiofrequency signal S′ is equal for example to 2.4 GHz+F_{IF}, where F_{IF} is the frequency of the signal of interest, and the frequency F_{LO} of the oscillation signal LO is for example equal to 2.4 GHz. One embodiment of the invention can also be implemented in a ZIF receiver, where the frequencies F_{LO} and F_{RF} are equal.

In general, an embodiment of the invention is implemented for frequencies F_{RF} and F_{LO} such that the absolute value of the ratio

$$\frac{{F}_{RF}}{{F}_{LO}}$$

is between 0.5 and 2 (not including 0.5 and 2).

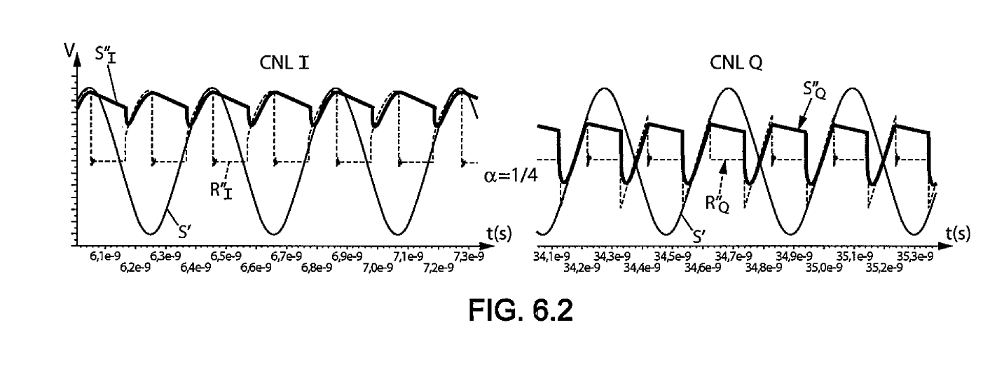

FIG. 6.1 represents for the channel I (left part of FIG. 6.1) the evolution during a window of time of the voltage of the signal S′ (thin line) provided as input to the mixer 100, of the signal S_{I}″ (thick line) which is the output signal when the capacitance value C1 of the capacitor 109 is low, and of the theoretical signal R_{I}″ (dotted line) which is the output signal when the capacitance value C1 of the capacitors 109 is zero in a theoretical scheme.

FIG. 6.1 represents for the channel Q (right part of FIG. 6.1) the evolution during a window of time of the voltage of the signal S′ (thin line) provided as input to the mixer 100, of the signal S_{Q}″ (thick line) which is the output signal when the capacitance value C1 of the capacitor 110 is low, and of the theoretical signal R_{Q}″ (dotted line) which is the output signal when the capacitance value C1 of the capacitor 110 is zero in a theoretical scheme.

As shown in FIG. 5.1 in the part relating to the channel I on the left side of FIG. 6.1, during a first phase τ1M of duration τ, the signal LOIM is in the high state and the signal LOIP is in the low state. The transistors M1 and M4 are conducting while the transistors M2 and M3 are non-conducting. The signal S_{I}″ provided during phase τ1M by the mixing module 102 (case where C1≠0), or the signal R_{I}″ provided during phase τ1 by the mixing module 102 (case where C1=0), is then equal to −S′.

Phases τ2M, τ3M etc., similar to this phase τ1M, occur every period of duration T.

Then during a phase t1, the signals LOIM and LOIP are both in the low state. The transistors M1, M2, M3 and M4 are non-conducting. The signal R_{I}″ provided during the phase t1 by the mixing module 102 (case where C1=0) is then equal to 0. The signal S_{I}″ provided during the phase t1 by the mixing module 102 (case where C1≠0) is then equal to the voltage delivered to the terminals of the capacitor 109 which discharges into the load impedance Z_{PMA} of the post-mixer amplifier 14, thus achieving in phase t1 an averaging of the values assumed by the voltage −S′ during the phase τ1M, until a pair of transistors becomes conductive once again. The mean of the signal S_{I}″ delivered during phase t1 is ultimately equal to the mean of the signal S′ over a period of time corresponding to the phase τ1M because in this embodiment the capacitance discharge into the impedance Z_{PMA} is negligible.

Phases t3, t5, etc., similar to this phase t1, occur every period of duration T.

Then, during a first phase τ1P of duration τ, the signal LOIP is at the high state and the signal LOIM is at the low state. The transistors M2 and M3 are conductive while the transistors M1 and M4 are non-conductive. The signal S_{I}″ provided during phase τ1P by the mixing module 102 (case where C1≠0), or the signal R_{I}″ provided during phase τ1P by the mixing module 102 (case where C1=0), is then equal to S′.

Phases τ2P, τ3P etc., similar to this phase τ1P, occur every period of duration T.

Then during a phase t2 (such that T=2τ+t1+t2), the signals LOIM and LOIP are both in the low state. The transistors M1, M2, M3 and M4 are non-conductive. The signal R_{I}″ provided during phase t2 by the mixing module 102 (case where C1=0) is then equal to 0. The signal S_{I}″ provided during phase t2 by the mixing module 102 (case where C1≠0) is then equal to the voltage delivered to the terminals of the capacitor 109, which once again discharges into the impedance Z_{PMA}, thus realizing in phase t2 an averaging of the values assumed by the voltage S′ during phase τ1P. The mean of the signal S_{I}″ delivered during phase t2 is ultimately equal to the mean of the signal S′ in phase τ1P because in this embodiment, the capacitance discharge into the impedance Z_{PMA} is negligible.

Phases t4, t6, etc., similar to this phase t2, occur every period of duration T. The operation of the mixing module 103 for the channel Q is similar to the mixing module 102 for the channel I, except the signals LOI and LOQ are out of phase by 90°.

The graphs discussed above correspond to a capacitance value C1 which is low or zero for the capacitors 109, 110. In practice, the capacitance value C1 is chosen to be sufficient in particular to filter out the second-order harmonics of the output signal from the mixing module 102. On the left side of FIG. 6.1 is represented the evolution during a window of time of the voltage of the signal T_{I} (represented by alternating short and long dotted lines) which is the output signal from channel I when the capacitance value C1 is chosen to be sufficient in particular to filter out the second-order harmonics. This signal T_{I} appears approximately rectilinear for the period in question. Its amplitude is approximately equal to the mean value of the signal S′ for phase τ1M.

Represented in the right part of FIG. 6.1 is the evolution during a window of time of the voltage of the signal T_{Q} (represented by alternating short and long dotted lines) which is the output signal from channel Q when the capacitance value C1 is chosen to be sufficient in particular to filter out the second-order harmonics. This signal T_{Q} appears approximately rectilinear for the period in question. Its amplitude is approximately equal to the mean value of the signal S′ for a phase where a pair of transistors is conductive.

FIG. 6.1 represents the voltage variations of signals delivered by the mixer 100 on channels I and Q when the duty cycle α of the oscillation signals LOIM, LOIP, LOQM, LOQP is equal to 0.1. FIG. 6.2 represents the variations in signals delivered by the mixer 100 when the duty cycle α for the oscillation signals LOIM, LOIP, LOQM, LOQP is equal to 0.25. The periods when the transistors are conductive are longer in FIG. 6.2.

The lower the value of the duty cycle α, the closer the mean value of the output signal S_{I}″ or S_{Q}″ to the maximum value of the signal S′.

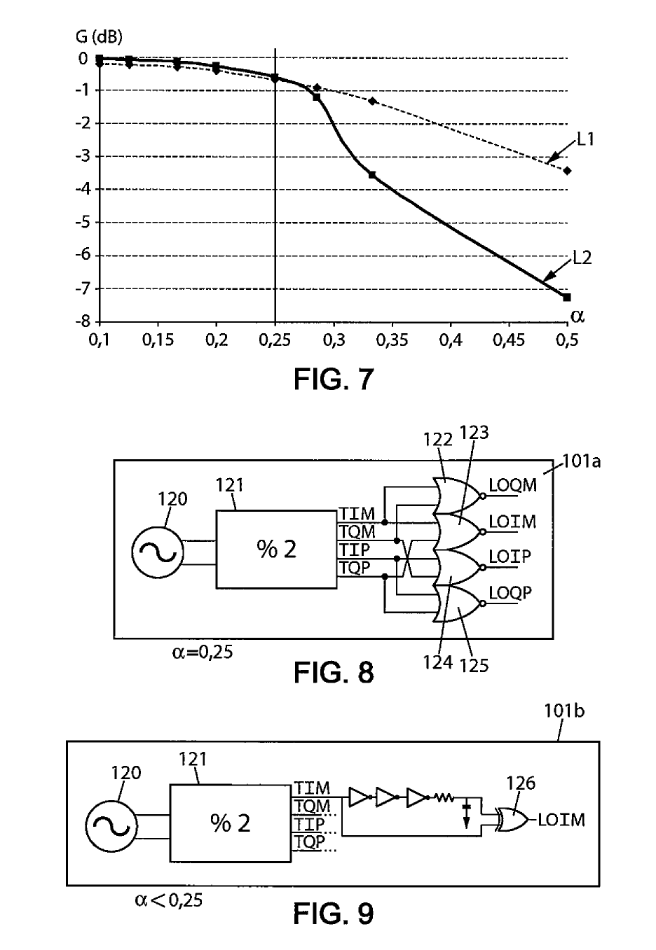

The voltage gain of a mixer 100 is represented in FIG. 7 as a function of the theoretical duty cycle α (rise and fall times for oscillation signals considered to be zero) for oscillation signals in two cases, respectively corresponding to the curves L1 and L2.

In actuality, the duty cycle α is calculated by considering a part of the rising and falling phases of the oscillation signals over time to be in the high state (as a function of the value of the common mode, meaning as a function of the bias voltage of the transistors corresponding to the switch), and therefore corresponds to a lower effective duty cycle, therefore to a greater gain.

The curve L1 corresponds to the case where the stage of the LNA module 2 represented in FIG. 1 upstream from the mixer 100 presents two separate output modules of the LNA delivering the voltage S′, one as input to the mixing module 102 for channel I, the other as input to the mixing module 103 for channel Q, in a manner unconnected to the output of said modules.

The curve L2 corresponds to the case where the stage of the LNA module 2 upstream from the mixer 100 presents an output module of the LNA which delivers the voltage S′ in a common manner to the mixing modules 102, 103 for channels I and Q, such as the module 120 represented in FIG. 4, comprising a source of current I_{LNA} and an impedance R1. The channels I and Q are then connected at the output from the LNA 2.

An output module of the LNA, for example a buffer circuit, is adapted to output a voltage which copies or even amplifies the voltage it receives as input, while presenting at the output to the mixer 100 a lower impedance than the impedance Z_{PMA} presented by the PMA amplifier 14 at the output of the mixer. An LNA can comprise such a circuit for each channel or one common to both channels, or such modules in a cascading arrangement.

For each of the curves L1, L2, the lower the duty cycle below 0.5, the greater the gain of the mixer 100. The increase in the gain is particularly noticeable when the duty cycle α is below 0.25. In such a case, no time period exists during which the oscillation signals LOIP and LOQP are both in the high state. Similarly, the oscillation signals LOIM and LOQM are never in the high state at the same time.

In fact, for the curve L1, the gain is about −3.8 dB for α=0.5, −0.9 dB for α=0.25, and progressively increases as a decreases, until it reaches −0.1 dB for α=0.1.

For the curve L2, the gain is about −7.4 dB for a =0.5, −0.9 dB for α=0.25, and progressively increases as a decreases, until it reaches −0.1 dB for α=0.1.

As can be seen by comparing curves L1 and L2, implementing the invention in a mixer eliminates the constraint of two separate modules at the output from the LNA, disconnecting channel I from channel Q when the duty cycle is less than 0.25. In fact, in the prior art, the use of two separate output modules for the LNA was advantageous because this avoided additional degradation in the gain due to a discharge of one of the two channels I, Q into the other channel when the channels I and Q were conductive at the same time.

When the duty cycle is less than 0.25 as described in the invention, there is no longer any moment when the channels I and Q are conductive simultaneously. There is therefore no more interference from one channel to the other. A common output module of the LNA shared by the channels I and Q allows an increased gain in comparison to two separate modules when the value of the duty cycle is less than 0.25. This also saves space in the integrated circuit of the system-on-chip.

In fact, the case considered in FIGS. 6.1 and 6.2, where the capacitance value of the capacitor 109 or 100 is zero, is a purely theoretical case, because the transistors M1, M2, M3 and M4 always present a non-zero stray capacitance.

The signals S_{I}″ and S_{Q}″, indicating the result of multiplications made by the mixing modules 102, 103 for channels I and Q, are then delivered to the PMA amplifier 14 as represented in FIG. 1, which will extract the component of interest for processing in the radiofrequency receiver (such as analog-to-digital conversion).

The load impedance Z_{PMA} must be sufficiently large not to discharge the capacitors 109, 110 when a pair of transistors (M1, M4) or (M2, M3) is conductive.

Each capacitor 109, 110 eliminates the high frequencies at the output from the mixer 100, particularly the components at ±(F_{RF}+F_{LO}). The more the duty cycle α decreases, the more the cutoff frequency Fc of the filter achieved by the capacitor 109, 110, beyond which the frequencies are eliminated, decreases. When a pair of transistors (M1, M4) or (M2, M3) are conductive, the pair R1.C1 defines the filtering. However, when all transistors are non-conductive, the resistance R1 as seen from the capacitor becomes infinite. Therefore the mean value of R1 as seen by the capacitor 109, 110 is

$$\frac{R 1}{2 α} .$$

### The cutoff frequency is therefore equal to

$$\frac{2 α}{2 π R 1 \times C 1} .$$

This enables a lower cutoff frequency while retaining the component situated at ±F_{IF}.

Reducing the value of the duty cycle also uses less space on the integrated circuit at the same cutoff frequency: by decreasing the duty cycle by a factor of two, the size of the capacitors 109, 110 is decreased by a factor of two.

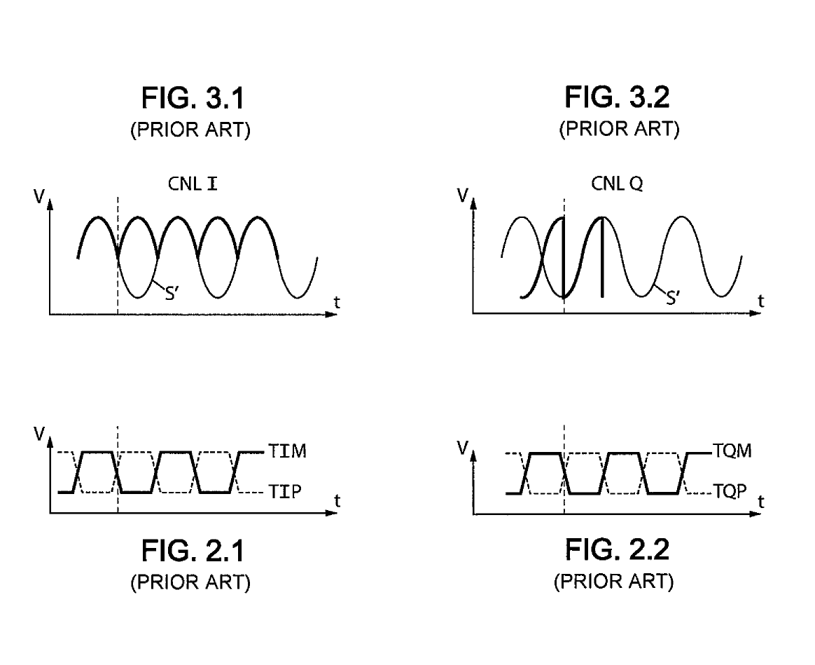

In one embodiment of the invention, a generator 101a of approximately square oscillation signals LOIM, LOIP, LOQM, LOQP of frequency F_{LO} and presenting a duty cycle α=0.25 is constructed by serially connecting, as shown in FIG. 8, a generator 120 of square signals of frequency 2 F_{LO} followed by a one-half frequency divider which delivers approximately square signals TIM, TQM, TIP, TQP of frequency F_{LO} similar to the signals represented in FIGS. 2.1 and 2.2. Then signals TIM and TQM are connected as input to a NOR logic gate 122 to obtain LOQM. Signals TIM and TQP are connected as input to a NOR logic gate 123 to obtain LOIM. Signals TIP and TQM are connected as input to a NOR logic gate 124 to obtain LOIP. Signals TIP and TQP are connected as input to a NOR logic gate 125 to obtain LOQP.

In other embodiments, NAND logic gates and inverters are used in place of NOR gates.

In one embodiment of the invention, in order to construct a generator 101b of approximately square oscillation signals LOIM, LOIP, LOQM, LOQP of frequency F_{LO} and presenting a duty cycle α strictly below 0.25, as shown in FIG. 9, serially connected as shown in FIG. 8 are a generator 120 of square signals of frequency 2 F_{LO} followed by a one-half frequency divider which delivers TIM, TIP signals in quadrature with TQM, TQP signals, all these signals being approximately square, of frequency F_{LO}, and similar to the signals represented in FIGS. 2.1 and 2.2. Then to construct the LOIM oscillation signal, the TIM signal and a signal equal to the delayed TIM signal (using an inverter and/or RC circuits) are connected as input to an XOR gate. In another embodiment, the XOR gates are replaced by NOR or NAND gates.

An embodiment of the invention was discussed above in a voltage-to-voltage mixer application, which means that the input source (the last stage of the low noise amplifier) is of relatively low impedance in comparison to the output load Z_{PMA}.

One embodiment of the invention was implemented above in an image rejection mixer. It can also be implemented in a mixer without image rejection and therefore not comprising a Q channel.

One embodiment of the invention was described above with a differential oscillation signal LOI, LOQ and a differential input signal S′. An embodiment can be implemented in a mixer adapted to multiply a signal received as input by a non-differential oscillation signal, called a single-ended signal, with the input signal itself being differential or single-ended.

One embodiment of the invention was described above with the use of CMOS technology. An embodiment can be implemented in integrated circuits comprising components based on other technologies such as AsGa or BiCmos.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A radiofrequency mixer, comprising:
a terminal from which, when operational, a first radiofrequency signal is available;
an input to receive a second radiofrequency signal; and
a means of multiplication for multiplying the first radiofrequency signal with the second radiofrequency signal,
wherein the first radiofrequency signal is:
either a differential signal corresponding to a difference between a first signal component and a second signal component, each corresponding to a respective signal which is approximately square and of a duty cycle less than 0.25,
or a single-ended signal which is a non-differential approximately square signal for which a duty cycle is less than 0.25.

2. The mixer according to claim 1, further comprising an output terminal to deliver a voltage indicating a result of the multiplication of the first radiofrequency signal and the second radiofrequency signal, and further comprising a capacitor parallel to said output terminal.

3. The mixer according to claim 1 wherein the first radiofrequency signal has a first frequency and the second radiofrequency signal has a second frequency, and wherein an absolute value of a quotient of the second frequency divided by the first frequency is between 0.5 and 2 not including 0.5 and 2.

4. The mixer according to claim 1 wherein the first radiofrequency signal is said differential signal and wherein the means of multiplication includes first and second differential input terminals and first and second differential output terminals, and additionally wherein:
the first differential input terminal is coupled to common sources of a first and a second transistor, the second differential input terminal is coupled to common sources of a third and a fourth transistor,
common gates of the first and fourth transistors receive the first signal component, and common gates of the second and third transistors receive the second signal component, and
the first output terminal is coupled to common drains of the first and third transistors, the second output terminal is coupled to common drains of the second and fourth transistors.

5. The mixer of claim 1 wherein said mixer is part of a system-on-chip.

6. A mobile telephone, comprising:
a generator to generate a first radiofrequency signal; and
a system-on-chip that includes:
a module to provide a second radiofrequency signal; and
at least one mixer module coupled to said generator and to said module to provide said second radiofrequency signal, said mixer module being adapted to multiply said first radiofrequency signal with said second radiofrequency signal,
wherein said first radiofrequency signal is either:
a differential signal corresponding to a difference between a first signal component and a second signal component, each corresponding to a respective approximately square signal having a duty cycle less than 0.25, or
a single-ended signal that is a non-differential approximately square signal having a duty cycle less than 0.25.

7. The mobile telephone of claim 6 wherein said mixer module includes:
first and second transistors having first terminals coupled together; and
third and fourth transistors having first terminals coupled together;
the first and fourth transistors having second terminals coupled together to receive said first signal component;
the second and third transistors having second terminals coupled together to receive said second signal component;
the first and third transistors having third terminals coupled together to provide a first output terminal; and
the second and fourth transistors having third terminals coupled together to provide a second output terminal.

8. The mobile telephone of claim 6 wherein said system-on-chip further includes a capacitor coupled to an output terminal of said at least one mixer module to receive a result of multiplication of said first radiofrequency signal with said second radiofrequency signal.

9. A method for processing signals, the method comprising:
receiving first and second radiofrequency signals; and
in a mixer, multiplying said first radiofrequency signal by said second radiofrequency signal,
the first radiofrequency signal being:
either a differential signal corresponding to a difference between a first signal component and a second signal component, each corresponding to a respective signal which is approximately square and of a duty cycle less than 0.25,
or a single-ended signal which is a non-differential approximately square signal for which a duty cycle is less than 0.25.

10. The method according to claim 9 wherein the first radiofrequency signal has a first frequency and the second radiofrequency signal has a second frequency, and an absolute value of a quotient of the second frequency divided by the first frequency is between 0.5 and 2 not including 0.5 and 2.

11. The method according to claim 9, further comprising:
an output terminal of the mixer delivering a voltage indicating a result of the multiplication of the first and second radiofrequency signals; and
receiving said voltage with a capacitor parallel to said output terminal.

12. An apparatus, comprising:
a first module to provide a first radiofrequency signal;
a second module to provide a second radiofrequency signal; and
at least one mixer module coupled to said first and second modules to respectively receive said first and second radiofrequency signals, said mixer module being adapted to multiply said first radiofrequency signal with said second radiofrequency signal,
wherein said first radiofrequency signal is either:
a differential signal corresponding to a difference between a first signal component and a second signal component, each corresponding to a respective approximately square signal having a duty cycle less than 0.25, or
a single-ended signal that is a non-differential approximately square signal having a duty cycle less than 0.25.

13. The apparatus of claim 12 wherein said second module and said mixer module are parts of a system-on-chip.

14. The apparatus of claim 12 wherein said mixer module includes:
first and second transistors having first terminals coupled together; and
third and fourth transistors having first terminals coupled together;
the first and fourth transistors having second terminals coupled together to receive said first signal component;
the second and third transistors having second terminals coupled together to receive said second signal component;
the first and third transistors having third terminals coupled together to provide a first output terminal; and
the second and fourth transistors having third terminals coupled together to provide a second output terminal.

15. The apparatus of claim 12, further comprising a capacitor coupled to an output terminal of said at least one mixer module to receive a result of multiplication of said first radiofrequency signal with said second radiofrequency signal.

16. The apparatus of claim 12 wherein said first module to provide said first radiofrequency signal includes:
a generator to generate square signals;
a frequency divider coupled to said generator to receive said generated square signals and to output approximately square signals; and
a logic circuit coupled to said frequency divider to receive said generated approximately square signals and to output oscillation signals.

17. The apparatus of claim 16 wherein said logic circuit includes a plurality of NOR logic gates or NAND logic gates.

18. The apparatus of claim 16 wherein said logic circuit includes an inverter coupled to an RC circuit, which is in turn coupled to an XOR, NOR, or NAND logic gate.
